(19) United States
(12) Patent Application Publication
(10) Pub. No.: US 2014/0067949 A1
(43) Pub. Date: Mar. 6, 2014

(54) METHOD AND APPARATUS

(71) Applicant: DIGITALES PTE LTD, Singapore (SG)

(72) Inventor: Daniel DEARLOVE, Singapore (SG)

(21) Appl. No.: 13/779,441

(22) Filed: Feb. 27, 2013

(30) Foreign Application Priority Data
Feb. 28, 2012 (SG) 201201415-5

(51) Int. Cl. H04L 29/08

(52) U.S. Cl. CPC H04L 67/306
USPC 709/204

(57) ABSTRACT

This invention relates to a method and apparatus for determining fame. In particular, this invention relates to method and apparatus for determining fame based on data extracted from the Internet. More particularly, but not exclusively, the data extracted is based on information available on social networks on the Internet.

### CROSS-REFERENCE TO RELATED APPLICATIONS

This utility application claims benefit under 35 U.S.C. §119(a) of Singapore Application No. 201201415-5, filed Feb. 28, 2012, which is hereby incorporated by reference.

### FIELD OF INVENTION

This invention relates to a method and apparatus for determining fame. In particular, this invention relates to method and apparatus for determining fame based on data extracted from the Internet. More particularly, but not exclusively, the data extracted is based on information available on social networks on the Internet.

### BACKGROUND OF THE INVENTION

A social network is a web application that facilitates the interaction of potentially thousands or millions of web users. Typically a social network will enable a user to create a customised page, containing personal information and will potentially also allow them to upload and share their own content, which, may range from short text update messages, through to longer “blog” text stories, photos, audio, video and other media.

Social networks typically allow users of their services to form connections between one another. Different networks have different terminology for this, such as becoming a “friend”, “fan”, “follower”, “subscriber” or “liking this”. Once you have become a “friend” of another user on a social network you have an ongoing connection with that user. You generally subscribe to certain content they may produce, such as text updates. And you are often able to communicate with one another through the social network in different ways. In addition, the number of “friends” you have, i.e. the number of connections that have been requested, and (if applicable) accepted, by you is frequently a public number, displayed on your personal customised page within the social network.

In addition to the number of “friends”, many social networks will also record and make publicly available other indicators of user interaction with your customised page or with your use of the social network, such as number of “views” you have received, number of “tweets” you have sent, number of user posts on your page and so on.

As social networks have become more ubiquitous, frequently it is not just private individuals that use and create accounts on them. Now, many brands, celebrities, politicians, sports teams, musicians and other public figures and organisations have their own pages across all the social networks. A number of users will become “friends” with each of them.

This number of “friends” may be an indicator of how popular a particular figure or organisation may be. And the rise and fall in this number is an indicator of increasing or decreasing popularity.

There have been devised methods for measuring social media influence and fame. However, because these methods measure “influence”, they do not provide an accurate or complete measure of social media fame—which is primarily a function of popularity. Also, these methods focus on social networks from the western world and do not generally include the Chinese and other non-English networks. Ultimately, there is nothing at present to aggregate public figures or personalities into comprehensive, cross genre, lists, charting social media fame. Present rankings generally only include personalities and brands who have opted into each service. Therefore, these rankings are very incomplete.

Therefore, there exists a need for an improved method and apparatus for determining and ranking fame.

### BRIEF SUMMARY OF THE INVENTION

In accordance with a first aspect of the invention, there is provided a method for determining forme, the method comprising: (a) extracting data relating to a personality or a brand; (b) creating an aggregate list of the personalities and brands; (c) calculating and allocating a score to a personality or brand based on the extracted data; and (d) outputting the calculated score and ranking the personalities or brands in the aggregate list based on the score.

In accordance with a second aspect of the invention, there is provided an apparatus for determining fame, the apparatus comprising: (a) an extraction unit for extracting data relating to a personality or a brand; (b) a processor for creating an aggregate list of the personalities and brands; (c) a calculation unit for calculating and allocating a score to a personality or brand based on the extracted data; and (d) an output unit for outputting the score calculated by the calculation unit and ranking the personalities or brands in the aggregate list based on the score.

Preferably, the data extracted may be the number of hits a personality or a brand gets mentioned on the Internet. This data may be collected and then collated from various social networks, including Google. Preferably, these social networks may be grouped into pre-determined categories. A custom content management system may be to used to provide an interface to easily link and categorise social network accounts in order to create an aggregated list of personalities and brands (which can then be ranked by their social media fame). The accounts are presented in descending order of fame and may be linked to an existing person or brand within a database, or create a new person or brand record in the database, and then categorise the person/brand. By this method a large number of social media accounts can be quickly categorised. The data (or number of hits/mentions) obtained may be rebased by providing various weightings depending on where the data is extracted (i.e. where a personality or a brand is mentioned on the Internet).

Advantageously, given the numerous number of social networks available on the Internet, the present invention measures fame with a formula that gives due weight to popularity across multiple networks. It therefore accurately represents actual social media fame. It also is able to accommodate and support the world's largest networks, inluding those from China and elsewhere neglected by other services. Scripts to retrieve social media stats from the public sites of the social networks (where no API exists) may be programmed. Here we have had to develop unique scripts to parse the html on these sites to retrieve the relevant statistics. These scripts may gather the largest public accounts from each network. These are gathered through a combination of crawling sitemaps, directories and rankings of pages on each network, and utilising API methods where available. Further, the present invention aims to include all major personalities and brands and social network accounts. The present invention does not just measure and aggregate stats for those personalities or brands who have authenticated or opted in to the service. Thus, the present solution provides a uniquely comprehensive perspective and ranking on social media fame.

In accordance with a third aspect of the invention, there is provided a computing device which is arranged to access one or more servers and obtain usage data from each server, the usage data giving information about an entity which uses a social network, the computing device being further arranged to collate the usage data for a plurality of social networks and generate entity data therefrom representative of that entities performance across a plurality of social networks.

As such, embodiments of the invention may seek to use these figures, across multiple social networks and in multiple ways to give an indication of popularity trends for people and organisations across social networks. Embodiments may also seek to use other publicly available figures, such as number of views, number of status messages sent, and so forth, to supplement this information and give more context on a user's popularity, and their usage trends within a social network.

Typically, the computing device may be arranged to display the entity data on a display thereof. However, the computing device may equally be arranged to store, transmit, or the like, the entity data for display or analysis elsewhere.

The servers which the computing device is arranged to access are typically remote from the computing device. As such, the computing device is generally arranged to make use of a network to access those servers. The network is typically the Internet.

Typically, the computing device will be a computer conforming to an X86 architecture and running one of a number of operating systems such as Microsoft™ Windows™, UNIX, Linux, etc., or be an Apple device running OSX, Microsoft™ Windows™, UNIX, Linux, etc. The computing device may be run as either a server or a client.

However, the skilled person will also appreciate that the computing device may any other suitable device such as a PDA, iPad, telephone, or the like.

In some embodiments, the computing device may be arranged to display the entity data so that it can be accessed across a network, such as the Internet/WWW. As such, the computing device may be operating as a web server.

An entity is typically a user of a social network and may represent an individual, an organisation, etc.

The skilled person will fully appreciate the term social network, but to exemplify this term examples are:

Twitter: http://twitter.com/
Facebook: http://www.facebook.com/
YouTube: http://www.youtube.com/
Bebo: http://www.bebo.com/
MySpace: http://www.myspace.com/
LinkedIn: http://www.linkedin.com/

According to a fourth aspect of the invention, there is provided a method of determining social network metrics, the method comprising the following steps: (a) accessing a first server to obtain usage data providing information about at least one entity using a first social network; (b) repeating step (a) for further social networks and such information may be retrieved regularly so it is up to date; (c) collating usage data received from different social networks and linking such accounts for each entity through a relational database, and calculating composite figures based upon usage across multiple social networks, to generate entity data representative of network statistics for at least one entity; (d) recording such usage data for each entity within a relational database on a periodic basis (for example, daily), along with the relevant date at which it was recorded, to accumulate a history of such usage data; (e) tagging such entity data by country/region and by a broad set of categories (for example Brand/retail, Brand/restaurant, Music/Rock, Music/Urban, Celebrity/Actor, Celebrity/Webstar, Sport/Athlete, Sport/Sports team), to enable the grouping and ranking of entity data within such categories/countries and any combination of each; and (f) displaying the entity data.

Such a method is advantageous as it may be used to provided a cross social network popularity tracker, based upon “friend” (e.g. entity) count, and related information from multiple social networks. That is, the entity data providing information about each user may be used to provide such popularity information across the different social networks.

The method may allow a user to rank entity data by any of the following: number of friends, friend growth and other metrics.

The method may allow a user to filter the entity data by any of the following: country, category, and potentially by other descriptive terms, to obtain popularity rankings for each of those countries/categories/terms.

The method may filter entity data to determine whether they are “official” pages within the context of such a popularity tracking application. Such a method is advantageous as it can help to ensure that the entity data does relate to user that is being profiled. The skilled person will appreciate that it is common for people to set up ‘spoof’ profiles which no do not relate to the person that it appears to. As such, filtering the entity data in this manner can help to ensure that the metrics are more robust.

The method may generate a composite index of social network popularity which is generated across the social networks accessed thereby.

The method may alternatively, or additionally, link data from social networks with other data that indicate a person or organisation's (i.e. entity) popularity (such as usage figures at their website, number of search engine results, number of related search queries), to form a further index of online popularity.

To display the data, the method may generate charts, and other insights around the data, based upon recording a history of such “friend” and related data, and querying it in multiple ways.

According to a fifth aspect of the invention there is provided a system which comprises a computing device arranged to access one or more servers and obtain usage data from the or each server, the usage data giving information about an entity which uses a social network, the computing device being further arranged to collate the usage data for a plurality of social networks and generate entity data therefrom representative of the at entities performance across a plurality of social networks and the system being arranged to display the entity data.

The system may also comprise a server which the computing device is arranged to access.

The system may comprise a web server arranged to display the entity data. In some embodiments, the web server arranged to display the entity data is different from the computing device arranged to generate the entity data. In such, embodiments, the computing device may be arranged to automatically transfer the entity data to the web server arranged to display the entity data.

According to a sixth aspect of the invention there is provided a machine readable medium containing instructions which when executed by a machine cause that machine to do any of the following: (a) perform as the computing device of the second and third aspects of the invention; (b) provide the method (or at least a part of the method) of the first and fourth aspects of the invention; or (c) provide the system (or at least a part of the system) of the fifth aspect of the invention.

The skilled person will appreciate that a feature above described in relation to any of the aspects of the invention may be applied mutatis mutandis to any other of the aspects of the invention.

Further, the skilled person will appreciate that aspects of the invention may be performed in software, hardware, or firmware or a combination of these. Yet further, the skilled person will appreciate that a ma chine readable medium as referred to above may be exemplified by any of the following: a floppy disk, a CD ROM/RAM (including −R/+R, −RW/+RW); a DVD, an HD DVD, a Blu Ray DVD, a hard disk drive, a memory (including an SD card, a compact Flash card, a Memory Stick™, a USB memory stick or the like), a transmitted signal (including an Internet download, an FTP transfer, or the like), a wire.

### BRIEF DESCRIPTION OF FIGURES

In order that the present invention may be fully understood and readily put into practical effect, there shall now be described by way of non-limitative examples only preferred embodiments of the present invention, the description being with reference to the accompanying illustrative figures.

In the Figures:

FIG. 1 is a screen shot showing a presentation of ranked list of data on a single social network, ranked by total “friends” (may also be ranked by growth trend in “friends”);

FIG. 2 is a screen shot showing figures for single social network, ranked by another metric (in this case Twitter Tweets);

FIG. 3 is a screen shot showing a presentation of ranked list for a single social network, based around certain countries or categories (in this case, pages from the United Kingdom, that are also Public Figures, and in the Politician sub category);

FIG. 4 is a screen shot showing a composite ranking of popularity based across multiple social networks;

FIG. 5 is a screen shot showing a composite ranking of popularity growth based across multiple social networks;

FIG. 6 is a screen shot showing a composite ranking of popularity and popularity growth, based across multiple social networks, along with statistics for individual social networks, in the style of a popularity “charts”;

FIG. 7 is a screen shot showing an example of detailed charts/graphs/analytics for social network popularity;

FIG. 8 is a network architecture in accordance with an embodiment of the present invention;

FIG. 9 is a flow chart showing the data gathering process;

FIGS. 10 A-D are screen shots showing applications themes according to an embodiment of the present invention, such that the data is presented in a legible and attractive manner;

FIG. 11 is a graphical representation of a formula in accordance with an embodiment of the present invention;

FIG. 12 is another graphical representation of a formula in accordance with an embodiment of the present invention; and

FIG. 13 is yet another graphical representation of a formula in accordance with an embodiment of the present invention.

### DETAILED DESCRIPTION OF THE INVENTION

Embodiments of the invention provides the concept, and workings of a cross social network popularity tracker based around “friend” (or similar) count and related data, with people and organisations tracked on the application categorized by country and category. Such “friends” are examples of an entity. The embodiments also provide for a composite index of popularity, aggregating and weighting data from multiple social networks, and also putting this into context with other online data on the person/organisation.

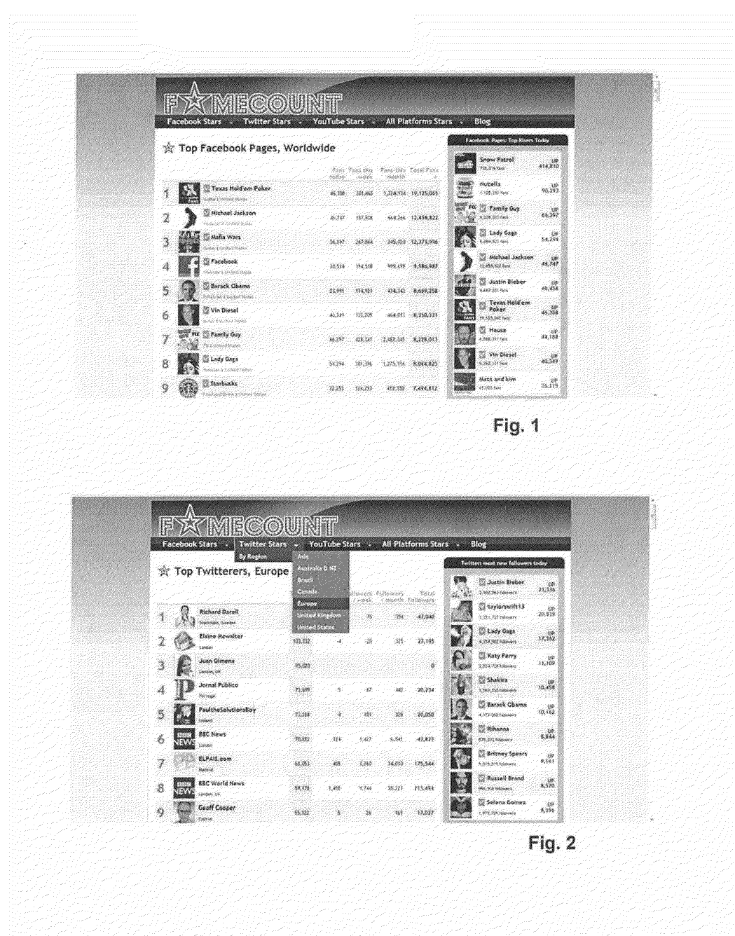

FIG. 1 illustrates how the application enables a user to view a ranked list of social network pages, based on the total number of “friends” those pages have, or the trend in growth in those friends. The figure also indicates that certain of these pages are marked as “official”—that is, where we have editorially determined that the page has been set up by the person/organisation it purports to represent.

FIG. 2 illustrates how the application enables a user to view a ranked list of social network pages, based on another metric being tracked, in this case the number of “tweets” sent by those pages.

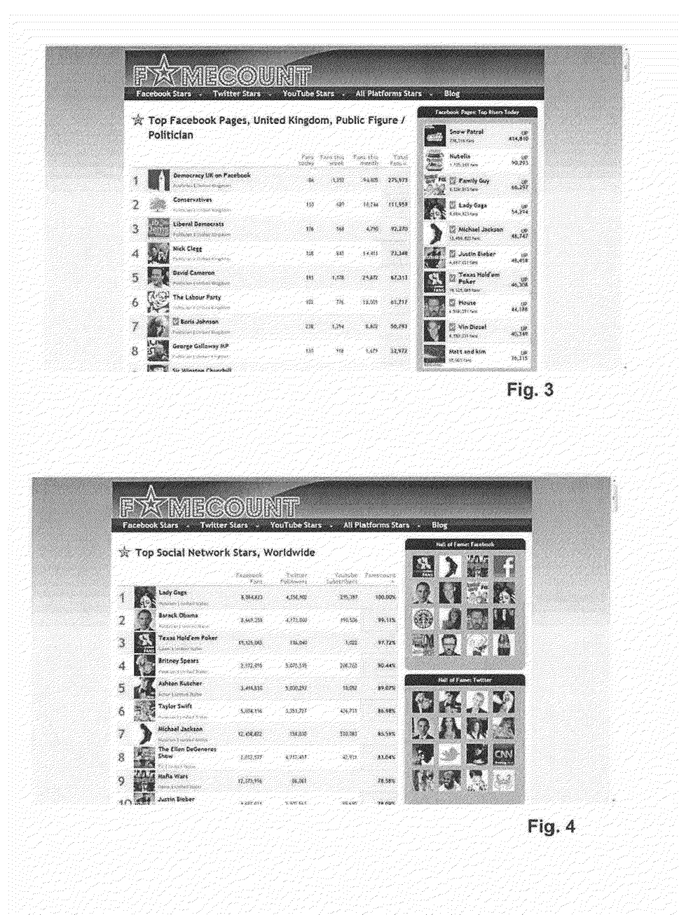

FIG. 3 illustrates how the application enables the user to filter the ranked list of social network pages by relevant (and potentially multiple) descriptive terms. In this case, it is by both country and category. In other words, the application gives the user the ability to view only those pages from a particular country and/or category and see each of those pages ranked by “friends” number or growth, or whichever other metric is chosen.

FIG. 4 illustrates how the application provides a composite index of popularity across multiple social networks. The application links a person or organizations social network pages across multiple social networks. So, for example, the person or organisation's customised page on Social Network A, is linked, within the database of the application, to their customised pages on Social Networks B and C. The application, on a periodic basis takes the “friends” and other data from each of these social networks, and calculates a weighted average measure of popularity across all networks, which weights “friends” data by the relative usage, and intensity of usage of each social network, and no the propensity of people to form “friends” on each network (as indicated by the average, or maximum number of friends on each network), and potentially by other factors to form a composite popularity measure, that aims to show who is most popular, overall, across social networks. This composite measure can then be further filtered by country and/or category (and possibly other descriptive terms).

An additional measure of popularity can be derived, by combining the popularity data across social networks, with additional online popularity data pertaining to that person or organisation. For example, reach, users, or page views at their official website; number of web pages, or news stories indexed by search engines such as Google; number of searches related to that person initiated at search engines such as Google.

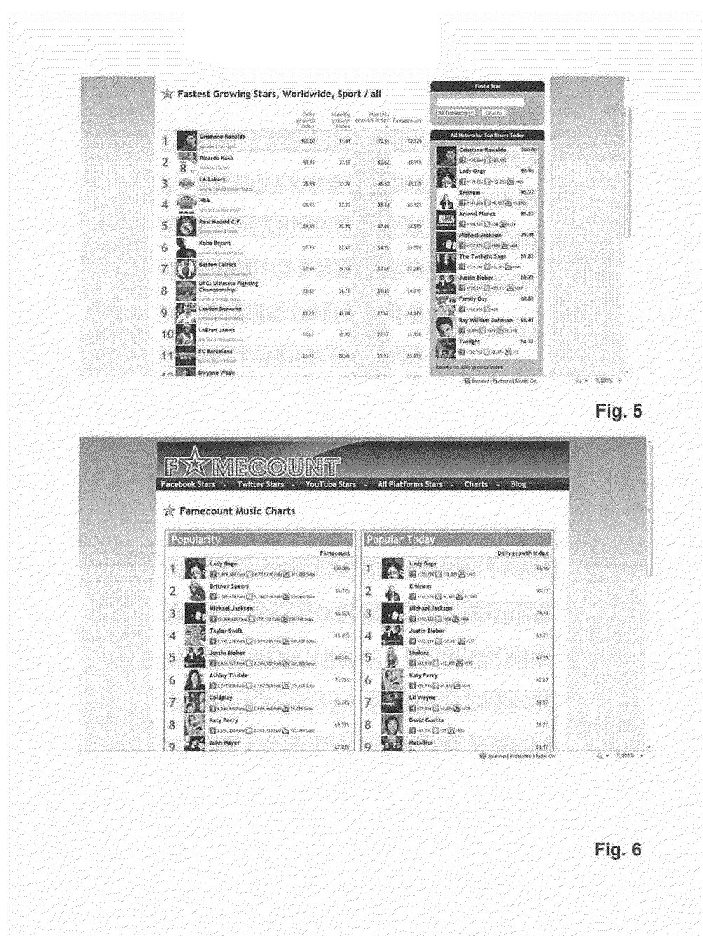

FIG. 5 illustrates how a composite measure of popularity growth can be calculated for entities having more than one social network profile. The method is similar to that for FIG. 4, only in this instance either the number of new “friends” on each network, or the percentage growth in friends, across a certain time period are used as the basis for the calculation. The growth measure can then be presented as an index, a percentage figure, an average friend growth figure or some other measure.

FIG. 6 illustrates how such growth figures can be presented, alongside overall popularity figures and friend figures by network to present a social network popularity “charts”, similar in style to traditional music charts derived from radio airplay or music sales.

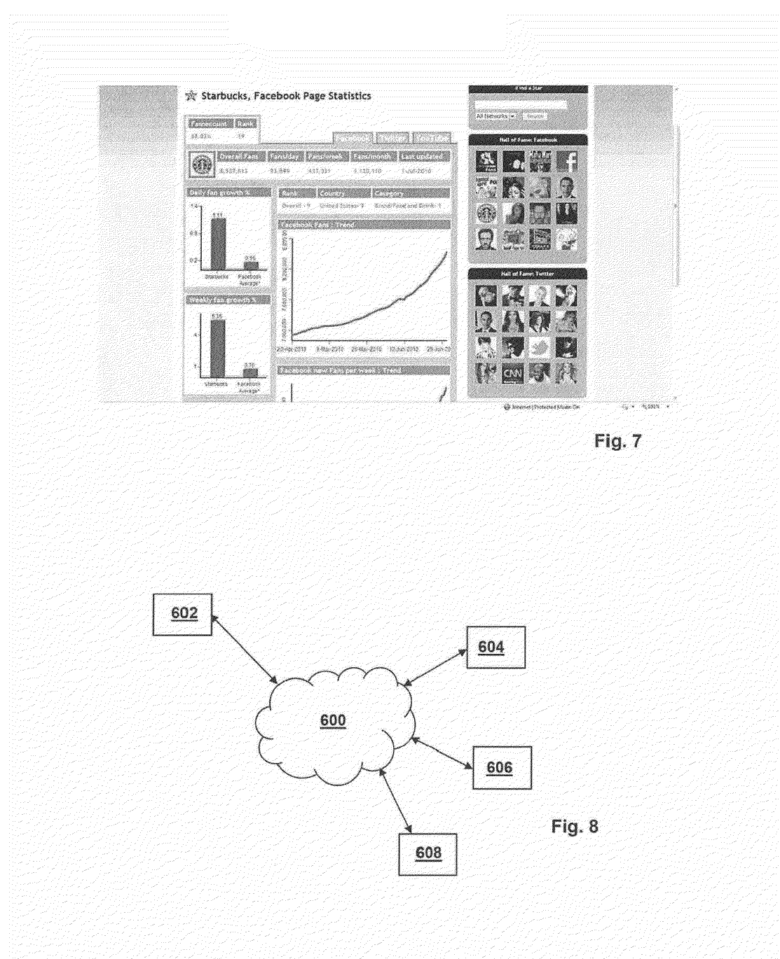

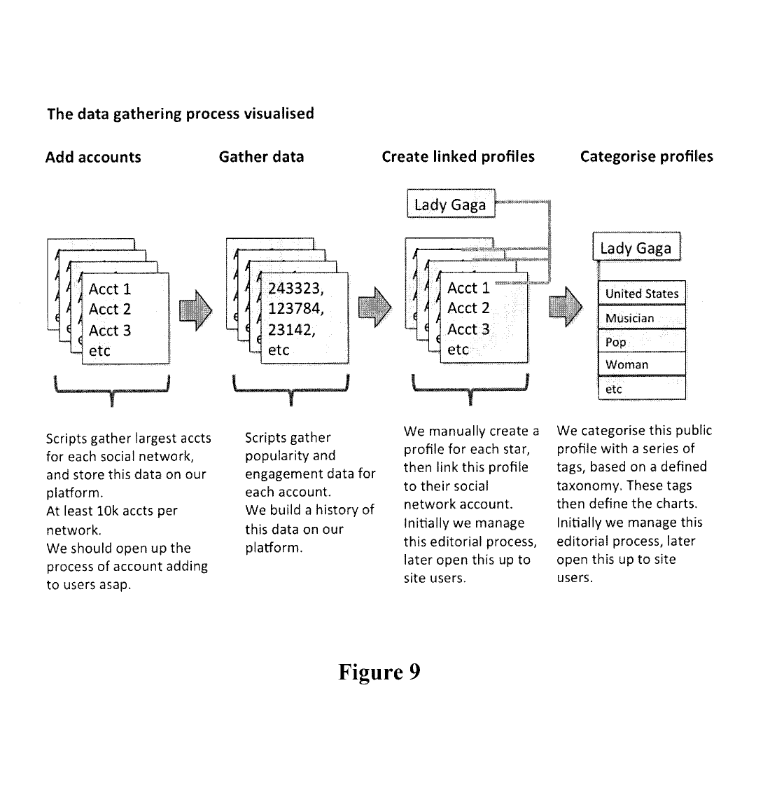

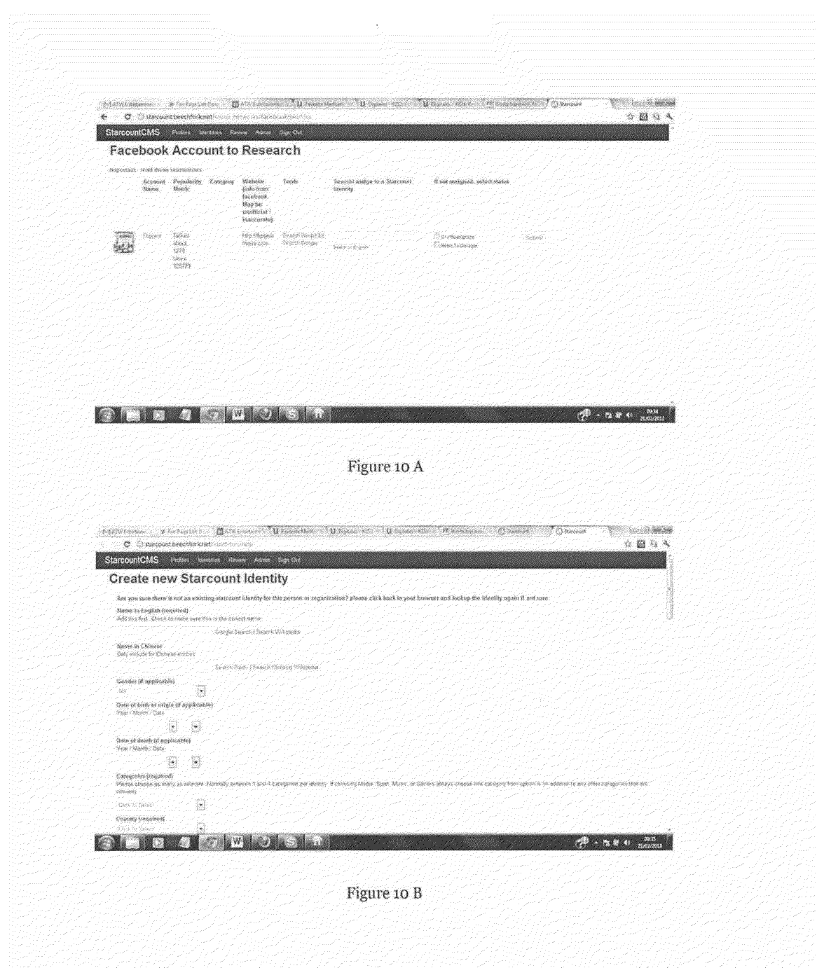

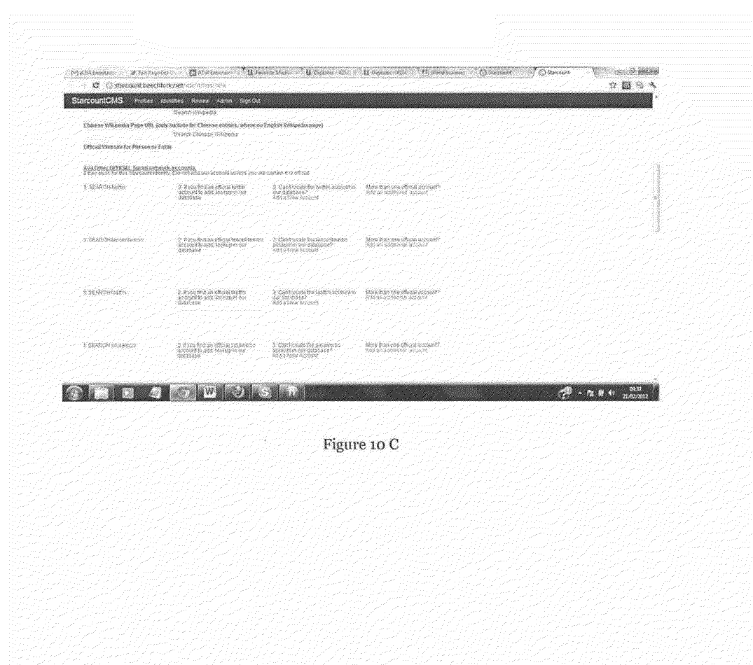

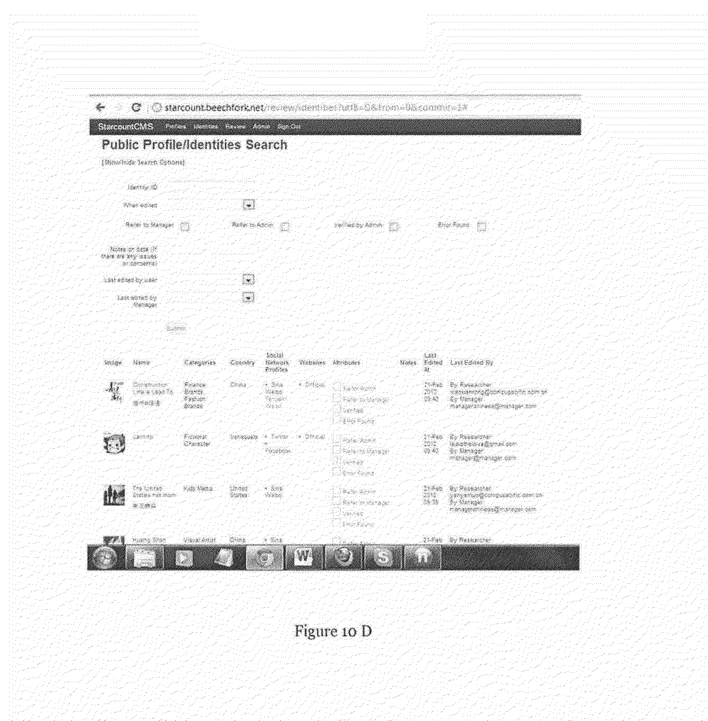

FIG. 7 illustrates how the application provides detailed trend figures and charts for each social network page. The charts can show, among other things, the growth in number of friends versus an average growth or other benchmark (calculated by averaging growth across the sample base of pages tracked), across different periods of time; number of friends, or growth in friends as a trend line over time; relative performance of one social network page versus another, or group of others, or versus a sector; market shares within particular segments; rankings, overall and within particular segments and versus other pages. As such, each of these constitute an example of entity data which is generated from usage data of a given social network. The application provides for the presentation of different social networks for each entity within a tabbed display, with each tab corresponding to a particular social network.

FIG. 8 shows an example network with a network 600 (in this case the Internet and World Wide Web) to which a computing device 602 has access. Servers 604, 606, 608 hold usage data relating to various social networks and the computing device 602 accesses those servers 604-8 to access usage data. The computing device 602 then generates entity data and displays this to it is accessible across the network 600.

Thus, in the embodiment being described, the computing device 600 is arranged to generate the screenshots shown in FIGS. 1 to 7 and those screen shows constitute examples of entity data generated by the computing device 600.

An embodiment of the invention is based around a database driven website or software application (e.g. provided on the computing device 600). The website may or may not utilise a content management system. The embodiment being described first entails uploading account details (username or account number) of numerous of the most popular user profiles from each of the social networks tracked to the database. These are typically provided in a list on the websites of the social network itself. They can be obtained either by copying and pasting details into a database or, where permitted, utilising a crawler application to obtain the data automatically.

The embodiment then uses programming scripts to retrieve up to date “friend” count (and other data) from each of the social networks (i.e. usage data). This is done by utilising the application programming interfaces (API's) provided by each social network. The scripts typically retrieve data for one page at a time.

To conform with terms for use of these API's it may be necessary to restrict the number of data requests made to each network at any one time. The scripts are therefore modified, such that they gather data for only a few pages at a time, and execute multiple times at regular intervals, such that data for each social network page is updated within a 24 hour cycle (or more or less regularly, as desired).

The scripts are further modified to accommodate the fact that social network pages may be deleted, such that a page is marked as obsolete when an API request for it no longer successfully executes. And the scripts are also modified to account for the fact that the API's are not always reliable, and the absence of a response does not always indicate that a page has been deleted—so a page shall only be marked as deleted once repeated calls for it's data have not met with a successful response.

Once all the social network page details are uploaded within the database, the next task is to editorially categorise the pages, by country, category, and any other descriptive term. The particular descriptions incorporated in this embodiment of the invention so far includes:
Countries: All the countries of the world, plus regions (e.g., Western Europe) and continents (e.g., Europe).
Categories: The following major categories: Music, Games, 5 Celebrities, Media, Politics, Brand, Sport, Institution, Other, Dislike. And within these, a range of sub categories, such as actor, politician, webstar, comedian, athlete, sports team, food and drink, fashion, TV, film, website, education, non-profit etc.

The process of editorial categorisation is partly automated. Based on retrieving certain information from the social network through it's API, and then writing programming scripts to turn that, often unstructured information into the more formal, structured categories in the database. It also involves significant manual, editorial effort, going through each social network page and deciding how it should be categorised.

Other embodiments may fully automate this editorial categorisation.

The pages are also then assessed, editorially, to determine whether they are “official pages”—set up by the person/organisation they purport to represent—or not. As such the usage data for an entity is collated across the social networks. In some cases this information may be retrieved through the API of the social network but otherwise, this is an editorial assessment made by ourselves.

Other embodiments may fully automate these collations. It will be appreciated that social networks may verify the identity of users. For example, Twitter verifies users as being authentic (currently by assigning a blue ‘tick’ to that profile). As such, embodiments of the invention may utilise such metrics in order to collate the usage data.

The next task, is to link the different social network pages within the database of the application. This is done by both automated means (utilising information made available from the social networks through their APIs) and through a manual editorial process of deciding which page from social network A is related to which pages from social networks B and C. Once the pages are linked, a script is written to take the fan data from each of them and calculate a weighted measure of performance. The weighted measure takes into account: the number of friends the person or organisation has on each network; the relative popularity of each network; the propensity to achieve “friends” on a network, as indicated by the maximum or average friends achieved by all users across each network; the levels of commitment implied in becoming a “friend” on each network.

As the API's of the social networks do not provide access to historic information (they only provide current “friend” numbers) to obtain historic or trend information, it is necessary to record such history within the database oneself. Further scripts are written which, on a daily basis, record for each social network page, the number of “friends” and other information for that day, and write that information to a separate table in the database. Through the accumulation of such data, it then becomes possible, over time to show trend growth and to calculate daily, weekly, monthly and other growth figures. Programming scripts are written to accomplish all of this.

Once all the above information is captured and recorded within the application, it is then possible to present the kind of information shown in the figures. To present this information, a series of complex queries of the database, and resulting html code, would need to be written to accommodate all of the different views of the data one wanted to achieve on the website. This could be done, at great effort, through writing customised scripts. Although typically, a powerful content management system may provide a way, within its user interface, of constructing these queries and linking them to a navigation system and to url paths within the application. In this instance, it may be possible to construct the views on the data with only minor customisations in the scripts contained within the content management system. The application may be themed, such that the data is presented in a legible and attractive manner.

The calculation score is intended to be a simple and accurate measure of aggregated fame across social networks. The measure is quantitative, not subjective.

Fame on social media is a function of both headline popularity—the number of people that connect, follow or view videos, and engagement—how much response or interaction is obtained from users. The present invention counts both. Unlike other services, the present invention does not attempt to understand or measure “influence” or “authority”, or seek to abstract complex numbers from the data. It takes into account popularity and fame as understood by consumers, producing straightforward rankings that make intuitive sense.

By “fame”, it is meant to include social networks beyond the western world. The present calculation unit covers the whole globe. It goes beyond Facebook, Twitter, YouTube, Last.fm and Spotify, and tracks the major social networks in China, Russia and other key markets, as well as important emerging networks to give the first truly global perspective on Fame. Priorities for integration include Weibo, RenRen & Youku (China), vKontakte (Russia), Orkut (Brazil, India and other markets).

In an embodiment of the present invention, data that have been extracted may be displayed on the application—i.e. the relevant popularity, and possibly engagement to data, for each network may be shown to a user. As such the rankings will be significantly more transparent than many other measures of fame and influence.

### Example

1) Add Activity Counts within Types of Social Networks

Social media encompasses a range of services each with their own sets of activities and metrics and our formula recognises this.

First, group social networks are grouped into four broad categories reflecting the type of activity they encompass and the data they generate. These are:
General social networks (such as Facebook, RenRen, Google+), where data such as fans, friends and connections are counted to gauge popularity; and comments, likes on posts and other interactions as our engagement measure.
Microblogs (such as Twitter and Weibo), where followers are tracked as per the popularity measure; and interactions such as mentions and retweets (and comments, in the case of Weibo) as per the engagement measure.
Video sharing (such as YouTube and Youku), where video views are counted as per the measure of popularity, and channel views and subscribers as per the measures of engagement.
Other Social networks, including genre specific services such as Last.fm and Spotify, photo sharing such as Flickr, and business networking such as Linkedin.

Within each category, the total number of popularity or engagement counts on each network is added for each personality or organisation (brand) to provide raw counts of popularity, and engagement, for general social networks, microblogs and video sharing, and other social networks. Figures for blogging may be displayed or disclosed, but these will not included in the calculation unit initially.

As each category of social network, and the data they produce, is different in nature, the data extracted and the numbers produced need to be comparable. This is done by looking in each case at how popular or engaged a personality or an organisation is in each category, versus the most popular personality or an organisation in each category. For example, what a personality's or an organisation's microblogging follower count is versus the most popular microblogger in the world. This gives us a set of scores ranging from 0-100 for popularity, and engagement in each social media category.

2) Aggregate Counts from Different Social Network Categories into a Single Measure

These numbers are then aggregated, from general social networks, microblogging, video sharing and other social networks, into a single measure of fame. The scores for popularity and engagement for each category of social network are added. As popularity more closely reflects “fame” than “engagement” (engagement tends to reflect the “passion” or “love” of a core fanbase, rather than the scale of fame more broadly), popularity is given a higher weighting in the present formula of calculation. In a non-limiting embodiment of the present invention, reflecting the different nature of each type of social networking and the different forms of behaviours they entail, a 40% weight to engagement is given on microblogging and 60% weight to popularity. For video sharing—15% engagement, 85% popularity is used. For general social networking and other social networks—25% engagement, 75% popularity is used. A summary of the various weightings is shown in Table 1.

TABLE 1

| Network | Network | Popularity | Engagement |
|---|---|---|---|
| Category | Weighting | Weighting | Weighting |
| General Social | 30% | 75% | 25% |
| Networks | | | |
| Microblogs | 30% | 60% | 40% |
| Video Sharing | 30% | 85% | 15% |
| Other Social | 10% | 75% | 25% |
| Networks | (when these | | |
| | networks are | | |
| | included) | | |

The scores for each category of social network are then compiled into a single aggregated score. Here, each major social network category (general social networks, microblogging, video sharing) is added together, giving each up to a third in the aggregated number. Up to a 10% weighting is given in total, to other social networks, as and when they are added (reflecting the fact that they are often focussed on a specific genre and may have lower reach and influence). This is then rebase to get a famecount score out of 100.

3) Apply Principle to Charts

This same methodology is used for all “Fame Charts”, whether daily, weekly, monthly, quarterly, year to date or all time. In each case, the popularity and engagement data for the entire relevant period is taken, where available.

As the all-time chart is intended as a measure of accumulated fame rather than the recent intensity of a fanbase, it is deliberately more focussed on popularity, than on what may be transient interactions and engagement in the past. Therefore, the most recent three months of engagement data for all-time charts is included and engagement is given a lower weighting—20% for microblogs, 15% for general social networks and other networks and 10% for video sharing. A summary of these weightings are shown in Table 2.

TABLE 2

| Network | Network | Popularity | Engagement |
|---|---|---|---|
| Category | Weighting | Weighting | Weighting |
| General Social | 30% | 85% | 15% |
| Networks | | | |
| Microblogs | 30% | 80% | 20% |
| Video Sharing | 30% | 90% | 10% |
| Other Social | 10% | 85% | 15% |
| Networks | (when these | | |
| | networks are | | |
| | included) | | |

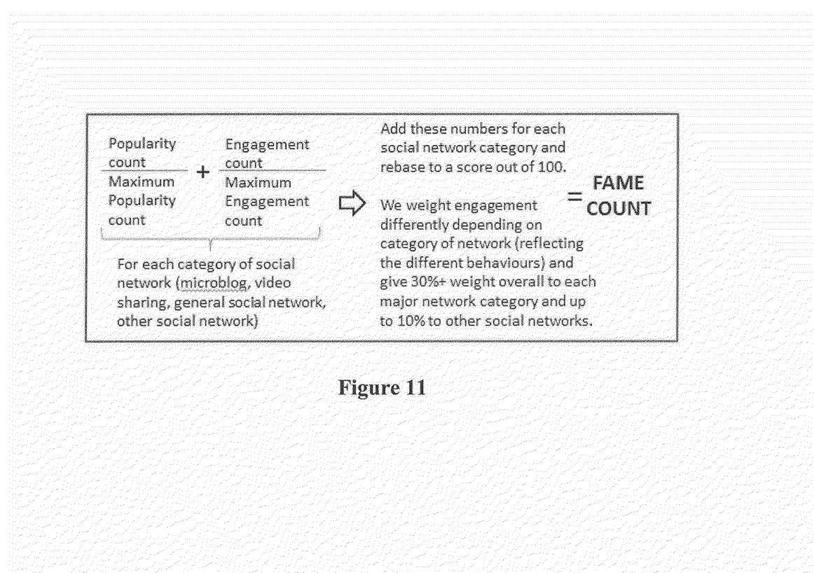

The above is expressed as a formula shown in FIG. 11.

Advantageously, the calculations are relatively simple—data is simply counted and similar activities are added on similar networks. The score will be most influenced by the networks that are most successful in encouraging users to connect or engage (they will have higher activity counts). The calculation unit is able to adjust and accommodate different kinds of networks, each with different behaviours and metrics. This also means that new networks can be added using the same principles.

The charts may be focussed on celebrities, music, TV shows, movies, sports teams and other entertainment stars and properties. Brands, non-profit organisations and other entities without a consumer, entertainment orientation may be excluded from the charts, although consumers will have the option of viewing charts containing all entities, and will be able to compare stars with brands on the core Famecount formula if desired.

Reflecting the fact that brands and other organisations use social media differently to many entertainment entities, and that marketers and others with an interest in brands on social media will have a different perspective on what they want from the data, an additional formula, and additional charts, may be used that is focussed specifically around brands.

The brand charts allow the presentation of information across multiple categories, sub categories and regions. It will also be the place where brand and marketing related editorial—such as coverage of exciting new campaigns and viral brand videos are displayed.

Reflecting the importance that brands place on direct engagement from their customers and the intensity of that engagement in the context of overall popularity—the brand fame formula or famecount will give a higher weighting to engagement across all networks. The formula will also give much greater recognition to the importance of business networking tools—in particular Linkedin.

Our brand formula will be as per the core fame formula, but with the weightings shown in Table 3

TABLE 3

| Network | Network | Popularity | Engagement |
|---|---|---|---|
| Category | Weighting | Weighting | Weighting |
| General Social | 25% | 50% | 50% |
| Networks | | | |
| Microblogs | 25% | 50% | 50% |
| Video Sharing | 25% | 50% | 50% |
| Business | 25% | 50% | 50% |
| Networks | | | |

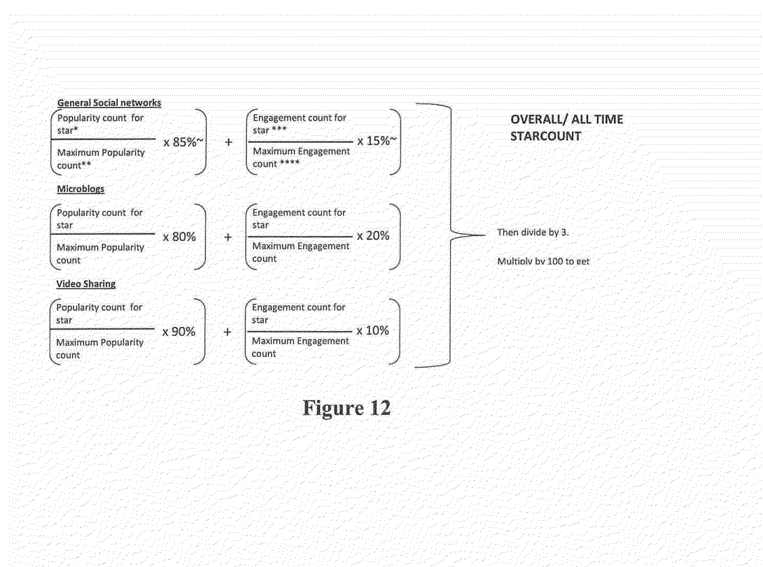

FIG. 12 provides a graphical representation of the formula and calculations described above.

*Example based on current data—James Blunt's combined Facebook likes, Google+ followers, RenRen fans

**The combined Facebook likes, Google+ followers and RenRen fans for highest individual record on each of these networks.

***James Blunts people talking about (only general social network engagement measure currently in the system) for last 3 months- or as much of this period as possible if we don't have 3 months history.

****The maximum record's value for people talking about.

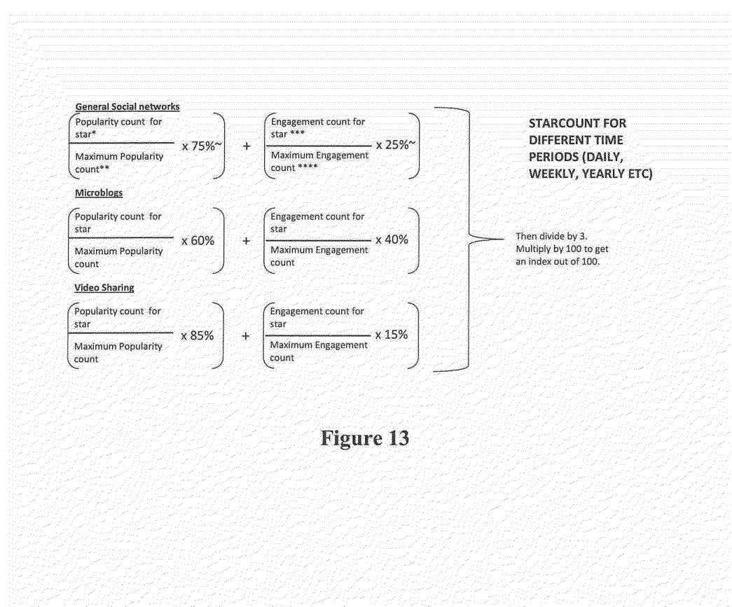

For daily/weekly etc charts the methodology is the same, except popularity/engagement weightings differ (see FIG. 13) & growth figures are taken into consideration. Where a metric is not cumulative (e.g. Facebook engagement—meaning what people talking about. Most of the other engagement numbers twill also be week to week numbers rather than cumulatively growing numbers) rather than take the growth in this number, the average over the period is taken. For the “all time chart” as shown in Diagram 1, 3-month average of such engagement data is taken, or an average of as much of the data as is obtained is taken.

Whilst there has been described in the foregoing description preferred embodiments of the present invention, it will be understood by those skilled in the technology concerned that many variations or modifications in details of design or construction may be made without departing from the present invention.

What is claimed is:

1. A method for determining fame, the method, comprising:
(a) extracting data relating to a personality or a brand;
(b) creating an aggregate list of the personalities and brands;
(c) calculating and allocating a score to a personality or brand based on the extracted data; and
(d) outputting the calculated score and ranking the personalities or brands in the aggregate list based on the score.

2. An apparatus for determining fame, the apparatus comprising:
(a) an extraction unit for extracting data relating to a personality or a brand;
(b) a processor for creating an aggregate list of the personalities and brands;
(c) a calculation unit for calculating and allocating a score to a personality or brand based on the extracted data; and
(d) an output unit for outputting the score calculated by the calculation unit and ranking the personalities or brands in the aggregate list based on the score.
